(19) United States
(12) Patent Application Publication
(10) Pub. No.: US 2023/0361418 A1
(43) Pub. Date: Nov. 9, 2023

(54) Battery and Non-Metallic Explosion-Proof Valve Structure Thereof

(71) Applicant: JIANGSU ZENERGY BATTERY TECHNOLOGIES CO., LTD., Jiangsu (CN)

(72) Inventors: Shengli CHEN, Jiangsu (CN); Xian ZHOU, Jiangsu (CN); Kun MA, Jiangsu (CN); Ruipeng ZHANG, Jiangsu (CN); Hongjiang YU, Jiangsu (CN)

(21) Appl. No.: 18/138,007

(22) Filed: Apr. 21, 2023

(30) Foreign Application Priority Data
May 9, 2022 (CN) 202221091790.5

(51) Int. Cl. H01M 50/342

(52) U.S. Cl. CPC H01M 50/3425

(57) ABSTRACT

The disclosure provides a battery and a non-metallic explosion-proof valve structure thereof, including a cover assembly, a housing and an injection molded part, the cover assembly and the housing are connected in a sealed manner, the cover assembly or the housing is provided with a through hole, the injection molded part is fixedly connected with the cover assembly or the housing provided with the through hole, and seals the through hole, a plurality of fixing holes are arranged in an area where the cover assembly or the housing is connected with the injection molded part, and the injection molded part is fixedly connected with the plurality of fixing holes. The non-metallic explosion-proof valve structure in the disclosure has good air tightness and structural strength when the battery is in normal operation, and can realize the directional exhausting function and avoid the battery explosion when the battery undergoes thermal runaway.

### CROSS-REFERENCE TO RELATED APPLICATION

The disclosure claims priority to and the benefit of Chinese Patent Application No. 202221091790.5, filed to the China National Intellectual Property Administration (CHIPA) on 9 May 2022, which is hereby incorporated by reference in its entirety.

### TECHNICAL FIELD

The disclosure relates to the technical field of lithium ion battery, in particular to a battery and a non-metallic explosion-proof valve structure thereof.

### BACKGROUND

Power battery has become an ideal power supply for portable electronic devices and electric vehicles due to its advantages of light weight, small size, large capacity, high power and non-pollution, etc. However, when the battery is abnormal, a large amount of gas will be generated inside the battery, resulting in a sharp increase in the internal pressure of the battery. At this time, if the large amount of gas generated is not eliminated in time, the battery will explode, causing a safety accident.

In order to ensure that the power battery has both high capacity and good safety and cycle life, an explosion-proof valve is generally provided on the top cover assembly of the power battery. When the power battery undergoes special circumstances (such as thermal runaway and short circuit, etc.), the explosion-proof valve of the power battery can be opened in time to exhaust the gas generated inside the power battery, thus improving the safety of the power battery.

As commonly used in the industry at present, the explosive-proof sheet made by impact-molding special aluminum materials is laser welded to the cover assembly of the lithium ion battery or the through hole of the housing, and the detonation pressure is controlled by the notch punched on the explosive-proof sheet. Such explosive-proof sheet has high requirements for texture of raw materials and notch depth, and its explosive index is greatly affected by the process and battery use. When it is welded to the cover assembly or housing, there are some problems such as probabilistic detonation point, loss of high quality rate and high cost, etc.

### SUMMARY

In view of the problems existing in the background technology, the disclosure aims to provide a battery and a non-metallic explosion-proof valve structure thereof, the non-metallic explosion-proof valve structure has good air tightness and structural strength when the battery is in normal operation, and can explode or melt through in time under violent gas production or local high temperature when the battery undergoes thermal runaway, realizing the directional exhausting function and avoiding the battery explosion.

In order to achieve the above object, the disclosure adopts the following technical solutions:

An embodiment of the disclosure provides a non-metallic explosion-proof valve structure of a battery, including a cover assembly, a housing and an injection molded part, the cover assembly and the housing are connected in a sealed manner, the cover assembly or the housing is provided with a through hole, the injection molded part is fixedly connected with the cover assembly or the housing provided with the through hole, and seals the through hole, a plurality of fixing holes are arranged in an area where the cover assembly or the housing is connected with the injection molded part, and the injection molded part is fixedly connected with the plurality of fixing holes.

In an implementation mode, the injection molded part includes a body part and a weak part, and the weak part is arranged on the body part.

In an implementation mode, the weak part includes a sunken structure, and the sunken structure includes an annular sunken structure or a cambered sunken structure.

In an implementation mode, the injection molded part includes a body part and a reinforcing part, and the reinforcing part is arranged on the body part.

In an implementation mode, the reinforcing part includes a plurality of reinforcing ribs, the reinforcing ribs are in a strip structure, one ends of the plurality of reinforcing ribs are connected, and the other ends are distributed radially.

In an implementation mode, the injection molded part includes a body part, a weak part and a reinforcing part. The weak part is arranged on the body part, the reinforcing part is arranged on the body part, and the weak part and the reinforcing part are matched in a cross-connection manner.

In an implementation mode, a diameter of a first opening of the through hole is larger than a diameter of a second opening of the through hole.

In an implementation mode, each of the plurality of fixing holes is a chemically etched or laser-engraved nanoscale fixing hole, and the plurality of fixing holes are arranged in regular or irregular distribution.

In an implementation mode, any one of the injection molded part and an inner wall of the through hole is provided with a convex part, the other one of the injection molded part and the inner wall of the through hole is provided with a concave part, and the convex part and the concave part are concave-convex matched.

Another embodiment of the disclosure also provides a battery, including the non-metallic explosion-proof valve structure as described above.

The disclosure has at least the following beneficial effects:

The non-metallic explosion-proof valve structure of the disclosure is provided with the plurality of fixing holes arranged in the area where the cover assembly or the housing is connected with the injection molded part, which increases the surface energy of the connection area, and thus can increase the connection strength between the injection molded part and the cover assembly or the housing. When the battery is in normal operation, the connection structure formed by the injection molded part formed by the injection molding of through hole and the connection area has good air tightness and structural strength. When the battery undergoes thermal runaway, due to the material strength of the injection molded part is less than the material strength of the cover assembly or the housing, the injection molded part can be broken through by the air pressure under violent gas production, and due to the melting point of the injection molded part is lower, the injection molded part can be softened or melted at local high temperature, reducing the connection strength between the injection molded part and the connection area, and internal pressure relief and explosion-proof functions of the battery can be achieved under violent gas production or local high temperature.

### BRIEF DESCRIPTION OF THE DRAWINGS

The features, advantages and technical effects of the exemplary embodiments of the disclosure will be described below with reference to the accompanying drawings.

FIG. 1 is a first structural schematic diagram of a battery in an embodiment of the disclosure.

FIG. 2 is a second structural schematic diagram of the battery in an embodiment of the disclosure.

FIG. 3 is a first cross-sectional structural schematic diagram of a non-metallic explosion-proof valve structure in an embodiment of the disclosure.

FIG. 4 is an exploded schematic diagram of FIG. 3.

FIG. 5 is a second cross-sectional structural schematic diagram of the non-metallic explosion-proof valve structure in an embodiment of the disclosure.

FIG. 6 is a third cross-sectional structural schematic diagram of the non-metallic explosion-proof valve structure in an embodiment of the disclosure.

FIG. 7 is a fourth cross-sectional structural schematic diagram of the non-metallic explosion-proof valve structure in an embodiment of the disclosure.

FIG. 8 is an exploded schematic diagram of FIG. 7.

FIG. 9 is a fifth cross-sectional structural schematic diagram of the non-metallic explosion-proof valve structure in an embodiment of the disclosure.

FIG. 10 is an exploded schematic diagram of FIG. 9.

FIG. 11 is a sixth cross-sectional structural schematic diagram of the non-metallic explosion-proof valve structure in an embodiment of the disclosure.

FIG. 12 is an exploded schematic diagram of FIG. 11.

FIG. 13 is a first structural schematic diagram of the non-metallic explosion-proof valve structure in an embodiment of the disclosure.

FIG. 14 is a top view of FIG. 13.

FIG. 15 is a second structural schematic diagram of the non-metallic explosion-proof valve structure in an embodiment of the disclosure.

FIG. 16 is a top view of FIG. 15.

FIG. 17 is a third structural schematic diagram of the non-metallic explosion-proof valve structure in an embodiment of the disclosure.

FIG. 18 is a fourth structural schematic diagram of the non-metallic explosion-proof valve structure in an embodiment of the disclosure.

Wherein, the reference symbols are explained as follows:
1—a cover assembly; 2—a housing; 3—a through hole; 31—an inner wall; 311—a fixing hole; 32—a first opening; 33—a second opening; 4—an injection molded part; 41—a body part; 42—a weak part; 43—a reinforcing part; 431—a reinforcing rib; 51—a convex part; 52—a concave part; 71—a first surface; 72—a second surface.

### DETAILED DESCRIPTION OF THE EMBODIMENTS

For example, certain words are used in the description and claims to refer to specific components, those skilled in the art should understand that hardware manufacturers may use different terms to refer to the same component. The description and claims do not use the difference of names as a way to distinguish components, but use the difference of functions of components as distinguishing criteria. For example, since the term “including” as mentioned throughout the description and claims is an open-ended language, it should be interpreted as “including but not limited to”. Term “approximately” means that within an acceptable error range, and those skilled in the art can solve the technical problems within a certain error range and basically achieve the technical effects.

In addition, the terms “first” and “second”, etc. are only used for descriptive purposes and cannot be understood as indicating or implying relative importance.

In the disclosure, unless otherwise specified and limited, the terms “installation”, “interconnection”, “connection”, “fixation”, and the like should be understood in a broad sense, for example, it can be either fixed connection, or detachable connection, or integrated connection; it can be either mechanical connection or electrical connection; and it can be either direct connection, or indirect connection through intermediate media, or it can be internal communication of two components. For those of ordinary skill in the art, the specific meanings of the above terms in the disclosure can be understood according to the specific situations.

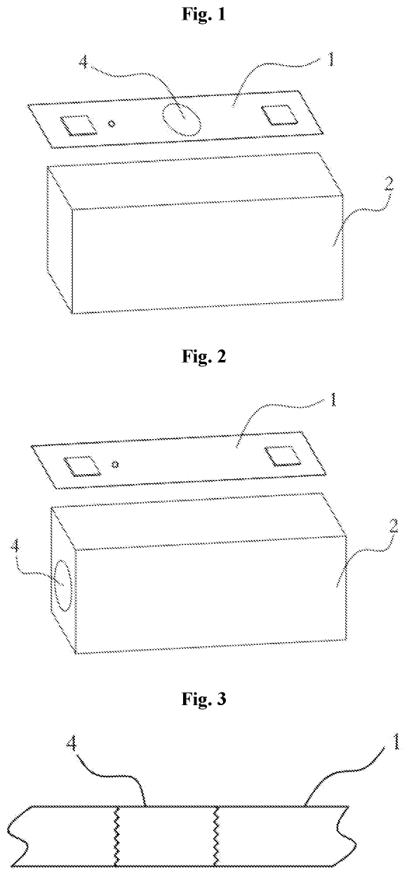

A battery and a non-metallic explosion-proof valve structure thereof of the disclosure will be further described in detail below with reference to FIGS. 1-18, which will not be used as a limitation to the disclosure.

As shown in FIGS. 1-2, the battery in the embodiment of the disclosure includes: a cell (not shown), a housing 2 and a cover assembly 1. The cell is an energy storage part and is assembled in the housing 2, the cover assembly 1 covers the housing 2, at the same time, the cover assembly 1 is electrically connected with the cell to assist in the introduction of electric energy into the cell or the export of energy in the cell.

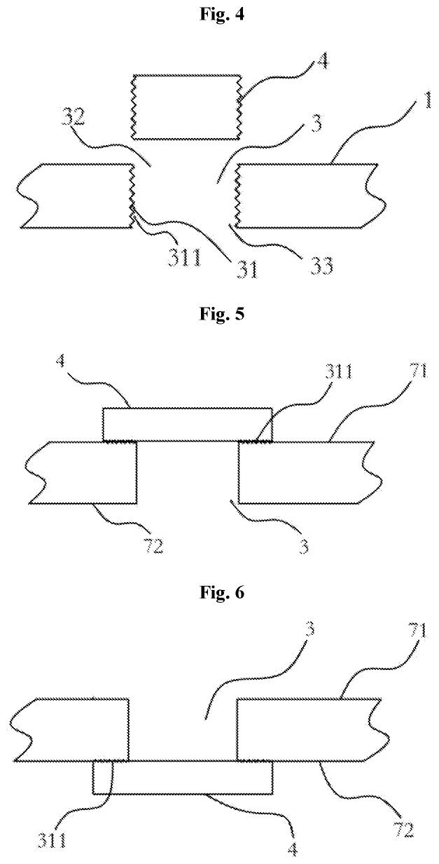

As shown in FIG. 3-18, the battery in the above embodiment of the disclosure uses a non-metallic explosion-proof valve structure, including the cover assembly 1 or the housing 2 provided with a through hole 3, and further including an injection molded part 4, the injection molded part 4 is fixedly connected with the cover assembly 1 or the housing 2 provided with the through hole 3, and seals the through hole 3, a plurality of fixing holes 311 are arranged in an area where the cover assembly 1 or the housing 2 is connected with the injection molded part 4, and the injection molded part 4 is fixedly connected with the plurality of fixing holes 311.

Specifically, FIG. 1 is an assembly structural schematic diagram of the battery with the through hole 3 arranged in the cover assembly 1 in an embodiment of the disclosure. The cover assembly 1 of the embodiment includes a first surface 71, a second surface 72 opposite to the first surface 71, and the through hole 3 running through the first surface 71 and the second surface 72. The first surface 71 of the cover assembly 1 refers to all surfaces that are not connected with the second surface 72 and can be observed from the side away from the second surface 72. The first surface 71 can be a whole plane or an uneven surface. The second surface 72 of the cover assembly 1 refers to all surfaces that are not connected with the first surface 71 and can be observed from the side away from the first surface 71. The second surface 72 can be a whole plane or an uneven surface. When the cover assembly 1 of the embodiment is configured for the power battery, the first surface 71 of the cover assembly 1 faces the housing 2 of the power battery, and the second surface 72 is exposed to the external environment. Since the through hole 3 runs through the first surface 71 and the second surface 72, an orifice of through hole 3 on the first surface 71 is a first opening 32, and an orifice of through hole 3 on the second surface 72 is a second opening 33.

In an embodiment, the cover assembly 1 has a predetermined length, width and thickness. The first surface 71 and the second surface 72 are arranged oppositely in the direction of thickness. The cover assembly 1 as a whole can be processed and manufactured by the molding process or by machining. At this time, the through hole 3 can also be processed by machining, such as drilling.

Specifically, FIG. 2 is a assembly structural schematic diagram of the battery with the through hole 3 arranged in the housing 2 in an embodiment of the disclosure. The housing 2 of the embodiment includes a bottom wall and a side wall as well as the through hole 3 running through the bottom wall or the side wall. The bottom wall and the side wall form the housing 2 with an opening at one end, and the cover assembly 1 is covered with the housing 2 to form a sealing cavity for containing the cell. The side of the bottom wall and the side wall close to the cell is the first surface 71, and the side of the bottom wall and side wall away from the cell is the second surface 72, the through hole 3 runs through the first surface 71 and the second surface 72, the orifice of through hole 3 on the first surface 71 is the first opening 32, and the orifice of through hole 3 on the second surface 72 is the second opening 33.

It should be noted that the housing 2 and a top cover are made of metal materials, which can be aluminum, steel, and aluminum alloy, etc., and there is no restriction thereto. The injection molded part 4 can be made of PS, ABS, PVC, and PE, etc.

In an embodiment, as shown in FIGS. 3-4, an inner wall 31 of the through hole 3 is provided with a plurality of fixing holes 311, and the fixing hole 311 has only one opening on the surface of the inner wall 31 of the through hole 3. The injection molded part 4 is formed in the through hole 3 by injection molding process, which reduces a processing difficulty of sealing the through hole 3. Because the injection molded part 4 is injection molded in the through hole 3, the injection molded part 4 is closely connected with the inner wall 31 of the through hole 3. In addition, because the inner wall 31 of the through hole 3 is provided with the plurality of fixing holes 311, the injection molding material will fill the plurality of fixing holes 311 during the injection molding, and the injection molded part 4 will also be fixedly connected with the plurality of fixing holes 311 after the injection molding material cools down.

In an embodiment, as shown in FIG. 5, a plurality of fixing holes 311 are arranged in the area where the first surface 71 of the cover assembly 1 or the housing 2 is connected with the injection molded part 4. The injection molded part 4 is formed on the first surface 71 by injection molding process. Because the injection molded part 4 is injection molded on the first surface 71, the injection molded part 4 is closely connected with the first surface 71. In addition, because the first surface 71 is provided with the plurality of fixing holes 311, the injection molding material will fill the plurality of fixing holes 311 during the injection molding, and the injection molded part 4 will also be fixedly connected with the plurality of fixing holes 311 after the injection molding material cools down.

In an embodiment, as shown in FIG. 6, the plurality of fixing holes 311 are arranged in the area where the second surface 72 of the cover assembly 1 or the housing 2 is connected with the injection molded part 4. The injection molded part 4 is formed on the second surface 72 by injection molding process. Because the injection molded part 4 is injection molded on the second surface 72, the injection molded part 4 is closely connected with the second surface 72. In addition, because the second surface 72 is provided with the plurality of fixing holes 311, the injection molding material will fill the plurality of fixing holes 311 during the injection molding, and the injection molded part 4 will also be fixedly connected with the plurality of fixing holes 311 after the injection molding material cools down.

It should be noted that the embodiment of the disclosure has no specific restrictions on the shape and structure of the through hole 3. The shape of the through hole 3 can be cylindrical, trapezoidal, square and other shapes and structures, as long as it can ensure that the gas inside the battery can be discharged when the battery undergoes thermal runaway. Accordingly, if the injection molded part 4 is injection molded in the through hole 3, the shape of the injection molded part 4 will match with the shape of the through hole 3.

The explosion-proof valve structure of the disclosure is provided with the plurality of fixing holes 311 arranged in the area where the cover assembly 1 or the housing 2 is connected with the injection molded part 4, which increases the surface energy of the connection area, and thus can increase the connection strength between the injection molded part 4 and the cover assembly 1 or the housing 2. When the battery is in normal operation, the connection structure formed by the injection molded part 4 formed by the injection molding and the connection structure formed by the cover assembly 1 or the housing 2 has good air tightness and structural strength. When the battery undergoes thermal runaway, due to the material strength of the injection molded part 4 is less than the material strength of the cover assembly 1 or the housing 2, the injection molded part 4 can be broken through by the air pressure under violent gas production, and due to the melting point of the injection molded part 4 is lower, the injection molded part 4 can be softened or melted at local high temperature, reducing the connection strength between the injection molded part 4 and the connection area, and internal pressure relief and explosion-proof functions of the battery can be achieved under violent gas production or local high temperature.

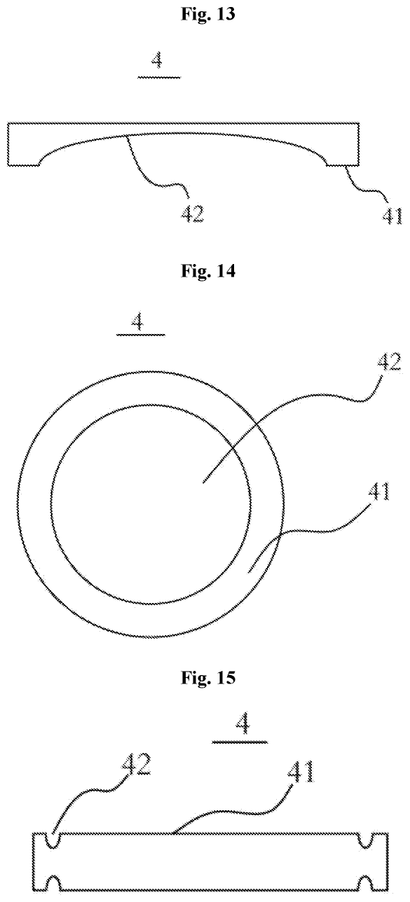

As shown in FIGS. 13-16, in an embodiment of the disclosure, the injection molded part 4 includes a body part 41 and a weak part 42, and the weak part 42 is arranged on the body part 41.

Since the weak part 42 is arranged on the body part 41, and a thickness of the weak part 42 is less than a thickness of the body part 41, the structural strength of the weak part 42 is lower relative to the body part 41. When the battery undergoes thermal runaway, the air pressure and temperature inside the battery rise rapidly, and the weak part 42 is easier to be broken through by the air pressure relative to the body part 41, so that the gas is discharged in time, or the weak part 42 is easier to be softened and melted by high temperature relative to the body part 41, reducing the connection strength between the injection molded part 4 and the inner wall 31 of the through hole 3, and discharging the gas in time.

It should be noted that since the weak part 42 in the embodiment of the disclosure is arranged to make the injection molded part 4 normally crack under the preset opening pressure, the weak part 42 can be arranged according to the opening requirements of the battery, such as parameters of depth, and width, etc. of the weak part 42, which can be determined by the actual needs of the battery specifically, and is not limited here.

It can be understood that the embodiment of the disclosure has no specific restrictions on the sunken shape structure, arranging mode and amount of the weak part 42. The sunken shape of the weak part 42 can be cylindrical, trapezoidal, square and other shapes, and the weak part 42 can be arranged at different positions such as the center or edge, etc. of the body part 41, the weak part 42 can be one or more, as long as the thickness of the weak part 42 is less than that of the body part 41, and can make the battery depressurize in time.

As shown in FIGS. 13-16, in an embodiment of the disclosure, the weak part 42 includes a sunken structure, and the sunken structure includes an annular sunken structure or a cambered sunken structure.

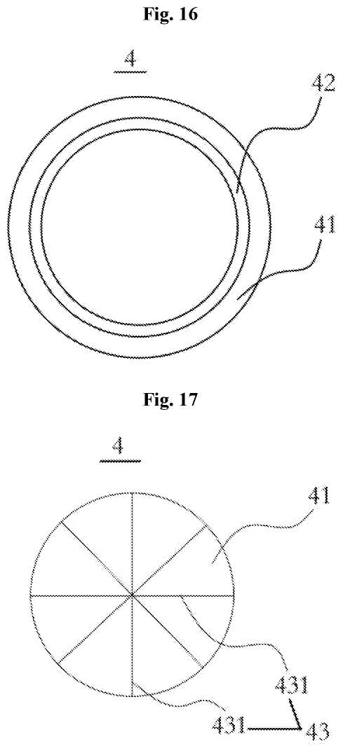

As shown in FIG. 13 and FIG. 16, specifically, when the battery undergoes thermal runaway, since the shape of the weak part 42 is the annular sunken structure, the effect of air pressure exerting force on the weak part 42 with the annular sunken structure can make the injection molded part 4 crack along the annular weak part 42, and after the annular weak part 42 cracks, a part of the body part 41 surrounded by the annular weak part 42 will separate from a part of the body part 41 not surrounded by the annular weak part 42 under the action of air pressure, forming a circular pressure relief channel for pressure relief, a diameter of the circular pressure relief channel depends on a diameter of the annular weak part 42, arranging the annular weak part 42 in the edge area of the body part 41 can maximize the area of the circular pressure relief channel, and thus can quickly discharge the internal gas to prevent the battery from further thermal runaway. Similarly, due to the thickness of the annular weak part 42 is small, it is easier to be softened and melted by high temperature, and it can be melted in time to form a circular channel. It can be understood that the annular structure can be either circular, square, diamond or other shapes.

As shown in FIG. 15 and FIG. 16, specifically, since the weak part 42 is the cambered sunken structure, that is, the first end face of the weak part 42 and/or the second end face of the weak part 42 is a concave cambered surface, a thickness of the injection molded part 4 gradually decreases from a junction of the weak part 42 and the body part 41 to the apex position of the cambered surface. When the battery undergoes thermal runaway, since the weak part 42 is arranged as the cambered sunken structure, the thickness at the apex position of the cambered surface is the smallest, and the gas can be gathered at the apex position along the cambered surface, so that the gas can be concentrated to apply pressure to the apex position of the cambered surface, and the apex of the cambered surface is first broken through by the pressure, and the gas inside the battery can be released in time. In addition, under the action of high temperature, it can also cause the apex of the cambered surface to soften or melt first, at the same time, other areas of the cambered surface are thinner than the thickness of the body part 41, so they are easier to be softened than the body part 41.

In an embodiment of the present disclosure, a projection of the weak part 42 in the longitudinal direction is an unclosed curve, such as arc, V-shaped or S-shaped, etc. Under the action of air pressure or temperature, the injection molded part 4 cracks along the weak part 42. Since the weak part 42 is arranged as the unclosed curve structure, it can still be connected with the body part 41 after the weak part 42 completely cracks. At this time, under the action of air pressure, the part of the body part 41 surrounded by the weak part 42 is turned over, and the gas is discharged through the exhaust vent that is turned over. By such arrangement, the injection molded part 4 can not only discharge the internal gas, but also ensure that the injection molded part 4 does not fall into the battery or splash.

As shown in FIG. 17, in an embodiment of the disclosure, the injection molded part 4 includes the body part 41 and a reinforcing part 43, and the reinforcing part 43 is arranged on the body part 41.

Specifically, since the reinforcing part 43 is arranged on the body part 41, a thickness of the reinforcing part 43 is greater than that of the body part 41, the structural strength of the reinforcing part 43 is higher than that of the body part 41, which strengthens the structural strength of the injection molded part 4. When the battery is transported or the injection molded part 4 is subjected to external force, the reinforcing part 43 can prevent the injection molded part 4 from being damaged by external force, reducing the risk of damage of the injection molded part 4.

It should be noted that the reinforcing part 43 in the embodiment of the disclosure is arranged to make the injection molded part 4 not easily damaged under pressure, but a main function of the injection molded part 4 is to open the pressure relief channel in time when the battery undergoes thermal runaway. Therefore, the reinforcing part 43 needs to be arranged on the premise of ensuring the opening requirements of the battery, such as the parameters of thickness, and width etc. of the reinforcing part 43, which can be determined by the actual needs of the battery, and will not be limited here.

It can be understood that the embodiment of the disclosure has no specific restrictions on the convex shape structure, arranging mode and amount of the reinforcing part 43. The convex shape of the reinforcing part 43 can be cylindrical, square, cambered and other shapes, or it can be a special-shaped structure formed by the combination of the above shapes. The reinforcing part 43 can be arranged at different positions such as the center and edge, etc. of the body part 41, and the reinforcing part 43 can be one or more, as long as the structural strength of the injection molded part 4 is increased by arranging the reinforcing part 43 on the body part 41 to avoid the easy damage of the injection molded part 4.

As shown in FIG. 17, in an embodiment of the disclosure, the reinforcing part 43 includes a plurality of reinforcing ribs 431, which are in a strip structure. One ends of the plurality of reinforcing ribs 431 are connected, and the other ends are distributed radially.

Specifically, the structural strength of the injection molded part 4 is reinforced by arranging the plurality of reinforcing ribs 431. At the same time, the reinforcing ribs 431 are arranged as the strip structure, and one ends of the reinforcing ribs 431 are connected, and the other ends are distributed radially, that is, one ends of the reinforcing ribs 431 are concentrated in the center of the body part 41, and the other ends are arranged clockwise in sequence. When the external force acts on the injection molded part 4, the plurality of reinforcing ribs 431 can distribute the pressure to each area of the injection molded part 4, so that each area of the injection molded part 4 is evenly stressed, preventing the situation that a certain area is easily damaged when the external force intensively acts on the certain area of the injection molded part 4.

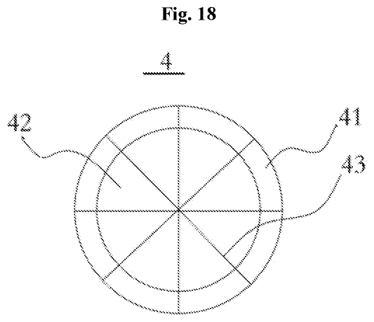

As shown in FIG. 18, in an embodiment of the disclosure, the injection molded part 4 includes the body part 41, the weak part 42 and the reinforcing part 43, the weak part 42 is arranged on the body part 41, the reinforcing part 43 is arranged on the body part 41, and the weak part 42 and the reinforcing part 43 are matched in a cross-connection manner.

Specifically, by arranging the weak part 42 and the reinforcing part 43 that are matched in the cross-connection manner on the body part 41, the weak part 42 can break in time to release the gas inside the battery when the battery undergoes thermal runaway. At the same time, when the weak part 42 of the injection molded part 4 is under the action of external force, due to the weak part 42 and the reinforcing part 43 are matched in the cross-connection manner, the reinforcing part 43 can enhance the structural strength of the weak part 42, so that the weak part 42 will not be so easily damaged. For example, as shown in FIG. 18, the weak part 42 is the cambered sunken structure in the above embodiment, and the reinforcing part 43 is a Pozidriv structure.

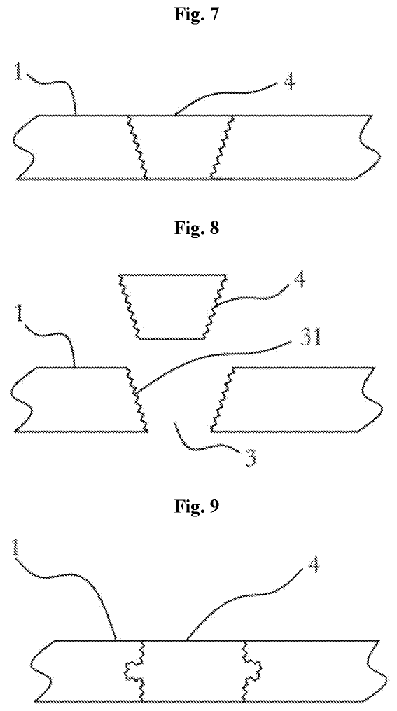

As shown in FIGS. 7-8, in an embodiment of the disclosure, a diameter of the first opening 32 of the through hole 3 is greater than a diameter of the second opening 33 of the through hole 3.

Specifically, by setting the diameter of the first opening 32 of the through hole 3 to be greater than the diameter of the second opening 33 of the through hole 3, the through hole 3 is changed into a circular table shape. Accordingly, the injection molded part 4 is also set to be the circular table shape so as to match with the through hole 3. As for the same diameter of the first opening 32 and the second opening 33, the connection area between the injection molded part 4 and the inner wall 31 of the through hole 3 can be increased in the embodiment, therefore, under the condition that the thickness of the housing 2 or the cover assembly 1 is fixed and the diameter of the second opening 33 is the same, that is, a height of the circular table shape is equal to a height of a cylindrical shape, and a diameter of a bottom surface of the circular table is equal to a diameter of and a bottom surface of the cylinder, because the diameter of the first opening 32 is greater than the diameter of the second opening 33, a lateral area of the circular table is larger than a lateral area of the cylinder. From the above description, it can be seen that the diameter of the first opening 32 of the through hole 3 is greater than the diameter of the second opening 33 of the through hole 3, which can increase the connection area between the injection molded part 4 and the inner wall 31 of the through hole 3, thereby increasing the connection strength between the injection molded part 4 and the inner wall 31 of the through hole 3, and at the same time, it can prevent the injection molded part 4 from falling into the battery to pollute the battery during pressure relief.

In an embodiment of the disclosure, each of the plurality of fixing holes 311 is a chemically etched or laser-engraved nanoscale fixing hole 311, and the plurality of fixing holes 311 are arranged in regular or irregular distribution.

Specifically, when the inner wall 31 of through hole 3 is chemically etched, since the chemical etching cannot control the distribution of the fixing holes 311, the plurality of fixing holes 311 chemically etched are irregularly distributed; and when the inner wall 31 of the through hole 3 is engraved by laser, since the laser can be controlled, the plurality of fixing holes 311 regularly or irregularly distributed can be obtained by controlling the laser. In an embodiment, the plurality of fixing holes 311 obtained by chemical etching or laser-engraving on the inner wall 31 of the through hole 3 are nanoscale, which increases the surface energy of the inner wall 31 of the through hole 3, and since the plurality of fixing holes 311 are nanoscale, the structural strength of the housing 2 or the cover assembly 1 will not be affected.

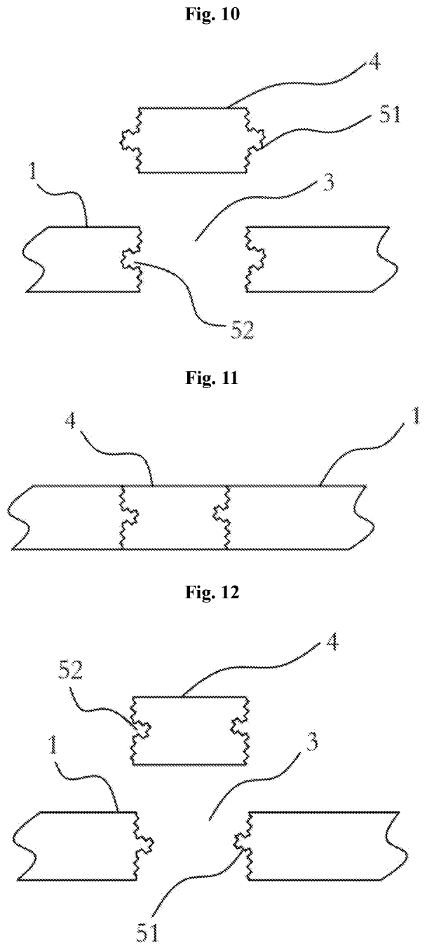

As shown in FIGS. 9-12, in an embodiment of the disclosure, any one of the injection molded part 4 and the inner wall 31 of the through hole 3 is provided with a convex part 51, and the other one of the injection molded part 4 and the inner wall 31 of the through hole 3 is provided with a concave part 52, and the convex part 51 and the concave part 52 are concave-convex matched.

There are two ways of arrangement in the above embodiments: the injection part 4 is provided with the convex part 51, the inner wall 31 of the through hole 3 is provided with the concave part 52, and the concave part 52 and the convex part 51 are concave-convex matched; the inner wall 31 of the through hole 3 is provided with the convex part 51, the injection molded part 4 is provided with the concave part 52, and the concave part 52 and the convex part 51 are concave-convex matched.

It should be noted that the concave part 52 in the embodiment of the disclosure can be an annular groove or an annular punctate groove. As shown in FIG. 9 and FIG. 10, when the concave part 52 is arranged on the inner wall 31 of the through hole 3, correspondingly, the convex part 51 is circled along the side wall connecting the injection molded part 4 and the inner wall 31 of the through hole 3 to make the convex part 51 match with the concave part 52, or the punctate convex part 51 is circled along the side wall connecting the injection molded part 4 and the inner wall 31 of the through hole 3 to make the convex part 51 match with the concave part 52. As shown in FIG. 11 and FIG. 12, when the concave part 52 is arranged on the side wall connecting the injection molded part 4 and the inner wall 31 of the through hole 3, correspondingly, the convex part 51 is arranged one circle horizontally along the inner wall 31 of the through hole 3, or a plurality of convex points are arranged one circle horizontally along the inner wall 31 of the through hole 3. It can be understood that the convex part 51 and the concave part 52 can also be set as other shapes and structures, as long as the concave part 52 and the convex part 51 can be concave-convex matched.

The arrangement of the convex part 51 and the concave part 52 enables the injection molded part 4 and the inner wall 31 of the through hole 3 to have larger connection area, which further reinforces the connection strength between the injection molded part 4 and the inner wall 31 of the through hole 3. At the same time, the arrangement of the convex part 51 and the concave part 52 enables the injection molded part 4 and the inner wall 31 of the through hole 3 not only to be connected by chemical bonds, but also to be clamped, so that the injection molded part 4 can be better fixed on the inner wall 31 of the through hole 3.

When the convex part 51 is arranged on the injection molded part 4, since a thickness of the convex part 51 is less than the thickness of the body part 41 of the injection molded part 4, and the convex part 51 is wrapped by the concave part 52, the convex part 51 can better accept the heat transferred from the housing 2 or the cover assembly 1. Therefore, when the battery undergoes thermal runaway, the convex part 51 can be softened or melted by heating in time, thus timely damaging the connection between the injection molded part 4 and the inner wall 31 of the through hole 3, so that the gas inside the battery can be released in time.

When the convex part 51 is arranged on the inner wall 31 of the through hole 3, since the concave part 52 of the injection molded part 4 wraps the convex part 51, the concave part 52 is divided into upper and lower parts by the convex part 51, and the thickness of the two parts is less than the thickness of the body part 41, when the battery undergoes thermal runaway, the convex part 51 transfers heat to the upper and lower parts of the concave part 52, so that the concave part 52 can be quickly heated to soften or melt, thus timely damaging the connection between the injection molded part 4 and the inner wall 31 of the through hole 3, so that the gas inside the battery can be released in time.

According to the disclosure and teaching of the above description, those skilled in the art can also change and modify the above embodiments. Therefore, the disclosure is not limited to the above specific embodiments. Any obvious improvement, replacement or modification made by those skilled in the art on the basis of the disclosure belongs to the protection scope of the disclosure. In addition, although some specific terms are used in this description, these terms are only for convenience and do not constitute any restriction on the disclosure.

What is claimed is:

1. A non-metallic explosion-proof valve structure of a battery, comprising a cover assembly and a housing connected in a sealed manner, the cover assembly or the housing is provided with a through hole, wherein it further comprises an injection molded part, the injection molded part is fixedly connected with the cover assembly or the housing provided with the through hole, and seals the through hole, a plurality of fixing holes are arranged in an area where the cover assembly or the housing is connected with the injection molded part, and the injection molded part is fixedly connected with the plurality of fixing holes.

2. The non-metallic explosion-proof valve structure according to claim 1, wherein the injection molded part comprises a body part and a weak part, and the weak part is arranged on the body part.

3. The non-metallic explosion-proof valve structure according to claim 2, wherein the weak part comprises a sunken structure, and the sunken structure comprises an annular sunken structure or a cambered sunken structure.

4. The non-metallic explosion-proof valve structure according to claim 1, wherein the injection molded part comprises a body part and a reinforcing part, the reinforcing part is arranged on the body part.

5. The non-metallic explosion-proof valve structure according to claim 4, wherein the reinforcing part comprises a plurality of reinforcing ribs, the plurality of reinforcing ribs are in a strip structure, one ends of the plurality of reinforcing ribs are connected, and the other ends are distributed radially.

6. The non-metallic explosion-proof valve structure according to claim 1, wherein the injection molded part comprises a body part, a weak part and a reinforcing part, the weak part is arranged on the body part, the reinforcing part is arranged on the body part, and the weak part and the reinforcing part are matched in a cross-connection manner.

7. The non-metallic explosion-proof valve structure according to claim 1, wherein a diameter of a first opening of the through hole is larger than a diameter of a second opening of the through hole.

8. The non-metallic explosion-proof valve structure according to claim 1, wherein each of the plurality of fixing holes is a chemically etched or laser-engraved fixing hole, and the plurality of fixing holes are arranged in regular or irregular distribution.

9. The non-metallic explosion-proof valve structure according to claim 1, wherein any one of the injection molded part and an inner wall of the through hole is provided with a convex part, the other one of the injection molded part and the inner wall of the through hole is provided with a concave part, and the convex part and the concave part are concave-convex matched.

10. A battery, comprising the non-metallic explosion-proof valve structure according to claim 1.
